(19) United States
(12) Patent Application Publication
(10) Pub. No.: US 2024/0268258 A1
(43) Pub. Date: Aug. 15, 2024

(54) LIQUID FLOW METER AND FLOW BALANCER AND ASSOCIATED DEVICES, SYSTEMS, AND METHODS

(71) Applicant: Ag Leader Technology, Ames, IA (US)

(72) Inventors: Scott Eichhorn, Ames, IA (US); Alan F. Barry, Nevada, IA (US)

(21) Appl. No.: 18/441,708

(22) Filed: Feb. 14, 2024

Related U.S. Application Data
(60) Provisional application No. 63/445,550, filed on Feb. 14, 2023.

(51) Int. Cl. A01C 23/04; A01C 23/00

(52) U.S. Cl. CPC A01C 23/047; A01C 23/007

(57) ABSTRACT

A system for flow control and measurement comprising a fluid tank, a pump in communication with the fluid tank, a manifold in communication with the pump configured to distribute fluid flow to two or more individual lines, and at least one flow device in line with each of the two or more individual lines. The at least one flow device comprising a housing, a hose disposed within the housing, a compression plate configured to compress the hose against the housing, the compression sufficient to close a lumen of the hose when fluid is not flowing through the hose, and at least one sensor configured to determine the position of the compression plate relative to the housing, where the position of the compression plate indicates pressure inside the hose.

### CROSS-REFERENCE TO RELATED APPLICATION(S)

This application claims the benefit under 35 U.S.C. § 119(e) to U.S. Provisional Application No. 63/445,550, filed Feb. 14, 2023, and entitled Liquid Flow Meter and Flow Balancer, which is hereby incorporated herein by reference in its entirety for all purposes.

### TECHNICAL FIELD

The disclosure relates to liquid application systems and related devices and methods, and particularly, liquid application systems for use in agriculture for the application of fertilizer and/or other products.

### BACKGROUND

As would be understood, liquid fertilizer application systems used on planters to apply starter fertilizer when planting have typically consisted of a positive displacement pump that can be set to apply a known amount of liquid per pump revolution. These positive displacement pumps can be variable displacement piston pumps, motor driven diaphragm pumps, or centrifugal pumps. In most cases, the positive displacement pump is driven at a speed that produces a known flow rate to produce the desired application rate per acre. Because travel speed can vary, many known systems use a ground driven pump with a variable displacement that can be preset. In other known cases, planters may use a speed control on a hydraulic or electric pump drive. In these prior known implementations, the pump speed and output flow can be increased or decreased as the travel speed varies.

In these prior known applications, the flow from the pump is divided among the number of rows on the planter so the actual pump output must be equal to the application rate per acre multiplied by the number of rows of fertilizer being applied with row spacing and travel speed factored in to determine the proper gallons per minute the pump must produce. In these known applications, there is typically zero or very little system pressure required. The fertilizer is allowed to pass out of the end of the delivery tube without any restriction and there is no excess flow returned to the tank. For example, a 12-row planter on 30″ rows with a desired application rate of 5 gallons per acre (GPM) and traveling at a speed of 6.6 mph would require a pump output of 2 GPM; at 8 mph the required pump output would be 2.42 GPM; and at 12 mph the required pump output would be 3.63 GPM.

In these prior known systems, flow from the pump is divided among the many rows using a manifold that has one inlet and many outlets, or a flow divider that divides the inlet flow into several equal output flows. The flow out from the manifold or flow divider is through individual hoses that can affect the even distribution of the liquid fertilizer. For example, if one hose is short and its path is largely downward from inlet to outlet, it may flow a larger part of the total flow than a second hose that is longer and may have some horizontal or upward paths to follow. The result of these prior known systems can be uneven distribution of the starter fertilizer resulting in some rows not getting enough liquid fertilizer and other rows getting too much.

In another example, if one distribution hose on a row becomes blocked or plugged, that row will not receive any fertilizer. In this example because the pump output remains the same, all the other rows will apply excess fertilizer resulting in uneven crop growth and lost yield potential. As would be understood, frequent inspections are required to catch such problems during the planting season, increasing time and decreasing efficiency of planting.

Other problems with prior known application systems include: incorrect pump settings resulting in under or over application rates; contamination in the fertilizer tank that plugs flow lines; partial blockage of a flow line due to a kink that forms after installation and goes undetected; drainage of the flow lines due to siphoning that causes no output in that line at the beginning of a pass until it refills; and others as would be appreciated.

Further, as would be understood, liquid fertilizer containing nitrogen is corrosive. Conventional devices used to measure or regulate flow such as turbine flow meters or metering valves can be subject to frequent failure and require a large amount of maintenance to keep them functional. Down time performing maintenance during the planting season can result in reduced yield potential and decreasing efficiency.

There is a need for improved flow control and measurement devices.

### BRIEF SUMMARY

In Example 1, a fluid flow device comprising a hose, a housing wherein the hose is contained within the housing, a compression plate in operational communication with the housing configured to compress the hose against the housing, and a least one distance sensor configured to measure a position of the compression plate.

Example 2 relates to the fluid flow device of any of Examples 1 and 3-9, wherein the distance sensor is one or more of a magnetic sensor, a vision sensor, and a rotary encoder.

Example 3 relates to the fluid flow device of any of Examples 1-2 and 4-9, wherein the distance sensor is a magnetic sensor.

Example 4 relates to the fluid flow device of any of Examples 1-3 and 5-9, further comprising a rib formed on the housing substantially opposite the compression plate.

Example 5 relates to the fluid flow device of any of Examples 1-4 and 6-9, wherein the compression plate compresses the hose against the rib when the compression plate is in a closed position.

Example 6 relates to the fluid flow device of any of Examples 1-5 and 7-9, further comprising an actuator in communication with the compression plate, the actuator configured to adjust the orientation of the compression plate relative to the hose.

Example 7 relates to the fluid flow device of any of Examples 1-6 and 8-9, wherein the compression plate is configured for movement in response to increase fluid flow pressure within the hose, and wherein movement of the compression plate is read by the at least one distance sensor.

Example 8 relates to the fluid flow device of any of Examples 1-7 and 9, wherein the position of the compression plate is indicative of a size of the hose opening within the housing and thereby of amount of fluid flowing through the hose.

Example 9 relates to the fluid flow device of any of Examples 1-8, wherein the size of the hose opening is dynamically adjustable via change in pump pressure and/or via a linear actuator in communication with the compression plate.

In Example 10, a flow control and measurement device, comprising a housing, a hose extending through the housing defining an orifice, a compression plate configured to press against the hose in the housing; and at least one position sensor configured to detect the position of the compression plate relative to the housing, wherein the compression plate compresses the hose until the orifice is closed when the compression plate is in an off position, and wherein pressure from fluid flowing through the hose causes movement of the compression plate detected by the at least one position sensor.

Example 11 relates to the flow control and measurement device of any of Examples 10 and 12-16, further comprising at least one linear actuator in communication with the compression plate, wherein the linear actuator urges the compression plate into a specified position to create a specified orifice size.

Example 12 relates to the flow control and measurement device of any of Examples 10-11 and 13-16, wherein the position sensor is a non-contact sensor.

Example 13 relates to the flow control and measurement device of any of Examples 10-12 and 14-16, wherein the position sensor is a magnetic sensor.

Example 14 relates to the flow control and measurement device of any of Examples 10-13 and 15-16, wherein the device is configured to determine flow rate by determining the size of the orifice from the position of the compression plate and a known pump pressure feeding into the hose.

Example 15 relates to the flow control and measurement device of any of Examples 10-14 and 16, further comprising at least one spring in communication with the compression plate, wherein the at least one spring forces the compression plate against the hose, and wherein the spring force may be overcome by fluid pressure within the hose urging the compression plate away from the housing.

Example 16 relates to the flow control and measurement device of any of Examples 10-15, further comprising at least one compression rib within the housing, wherein the hose is pitched between the compression plate and the hose when the compression plate is in the off position.

In Example 17, a system for flow control and measurement, comprising a fluid tank, a pump in communication with the fluid tank, a manifold in communication with the pump configured to distribute fluid flow to two or more individual lines, and at least one flow device in line with each of the two or more individual lines. The at least one flow device comprising a housing, a hose disposed within the housing, a compression plate configured to compress the hose against the housing, the compression sufficient to close a lumen of the hose when fluid is not flowing through the hose, and at least one sensor configured to determine the position of the compression plate relative to the housing, wherein the position of the compression plate indicates pressure inside the hose.

Example 18 relates to the system for flow control and measurement of any of Examples 17 and 19-20, further comprising comparing the pressure of each of the flow devices allows the system to determine if an individual line is blocked.

Example 19 relates to the system for flow control and measurement of any of Examples 17-18 and 20, wherein the system equalizes flow amongst the two or more individual lines.

Example 20 relates to the system for flow control and measurement of any of Examples 17-19, wherein the position of the compression plate indicates if a blockage is present.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of the flow device, according to one implementation.

FIG. 2 is a top view of the flow device with upper housing removed, according to one implementation.

FIG. 3 is a top view of the flow device with the hose removed from the housing, according to one implementation.

FIG. 4 is a top view of the flow device with the compression plate separated from the housing, according to one implementation.

FIG. 5 is a side, cross-sectional view of the device is a closed state, according to one implementation.

FIG. 6 is a side, cross-sectional view of the device is a flowing state, according to one implementation.

FIG. 7 is schematic view of a liquid application system, according to one implementation.

FIG. 8 is a side, cross-sectional view of the device with a blockage, according to one implementation.

FIG. 9 is a side, cross-sectional view of the device with a linear actuator, according to one implementation.

FIG. 10 is a side, cross-sectional view of the device with a rotary actuator, according to one implementation.

### DETAILED DESCRIPTION

Described herein is a liquid application system including an expansion hose type liquid flow meter and flow balancer for use in applying various liquids, including liquid fertilizer, to agricultural fields. Other applications of the system and devices are possible and contemplated herein. The devices, systems, and methods disclosed herein provide for flow control and measurement across a range of flow rates through a common flow line (total pump output) and/or individual delivery flow lines. The various devices, systems, and methods may be configured to measure the rate a fluid is applied at individual outputs.

In various of the disclosed implementations, there is no direct contact of the measuring devices with the liquid material passing through, improving the life of the device and decreasing corrosion, as will be discussed further herein. In certain implementations, there are no impellors to turn, no electronic components in contact with the measured material, and no passage openings for sensing device installations which need to be sealed as are common in prior known devices and systems, discussed above.

The disclosed device has several potential applications. The various devices, systems, and methods can be used as (1) a non-contact flow meter either individually or as a group of sensors; (2) a non-contact flow blockage sensor either individually or as a group of sensors; (3) a self-actuating flow shut off device to prevent siphoning from draining drop hoses; (4) a flow equalizing device when used in parallel on multiple supply hoses; and/or (5) a flow shut off and metering valve with the addition of a controlled hose compression actuator. Other applications or combinations of applications are possible and would be appreciated by those of skill in the art in light of this disclosure.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16,523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,334, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. Patent Application 63/466,144, filed May 12, 2023, entitled “Devices, Systems, and Methods for Providing Yield Maps,” U.S. Patent Application 63/466,560, filed May 15, 2023, entitled “Devices, Systems, and Methods for Agricultural Guidance and Navigation,” U.S. Patent Application 63/524,065, filed Jun. 29, 2023, entitled “Ring Assembly,” U.S. Patent Application 63/525,525, filed Jul. 7, 2023, entitled “Assisted Steering Systems and Associated Devices and Methods for Agricultural Vehicles,” U.S. Patent Application 63/593,837, filed Oct. 27, 2023, entitled “Agricultural Implement Position Sensor and Related Devices, Systems, and Methods,” U.S. Patent Application 63/603,969, filed Nov. 29, 2023, entitled “Devices, Systems and Methods for Guidance Line Shifting,” U.S. Patent Application 63/607,227, filed Dec. 7, 2023, entitled “Header Height Control Devices, Systems and Methods,” U.S. Patent Application 63/609,758, filed Dec. 13, 2023, entitled “Magnetic Stripper/Deck Plate Sensing System,” each of which is incorporated herein by reference.

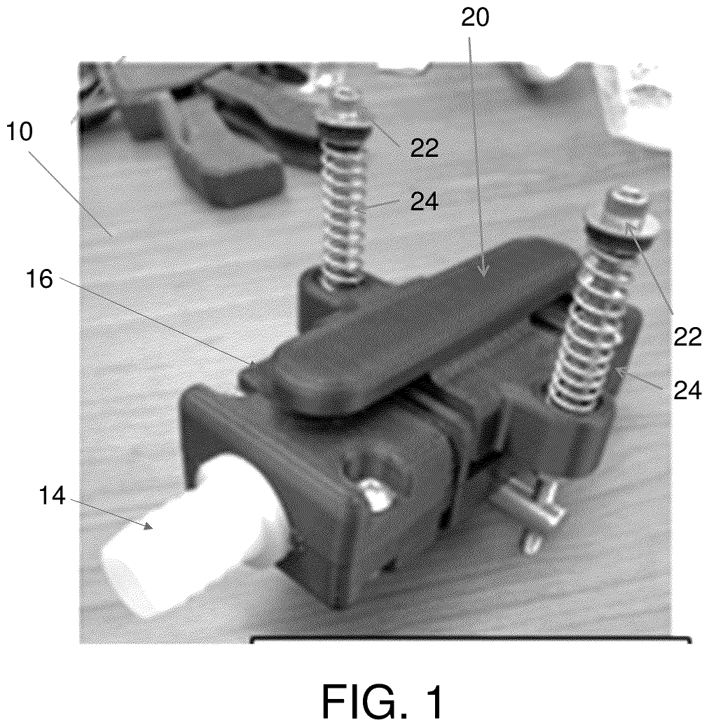

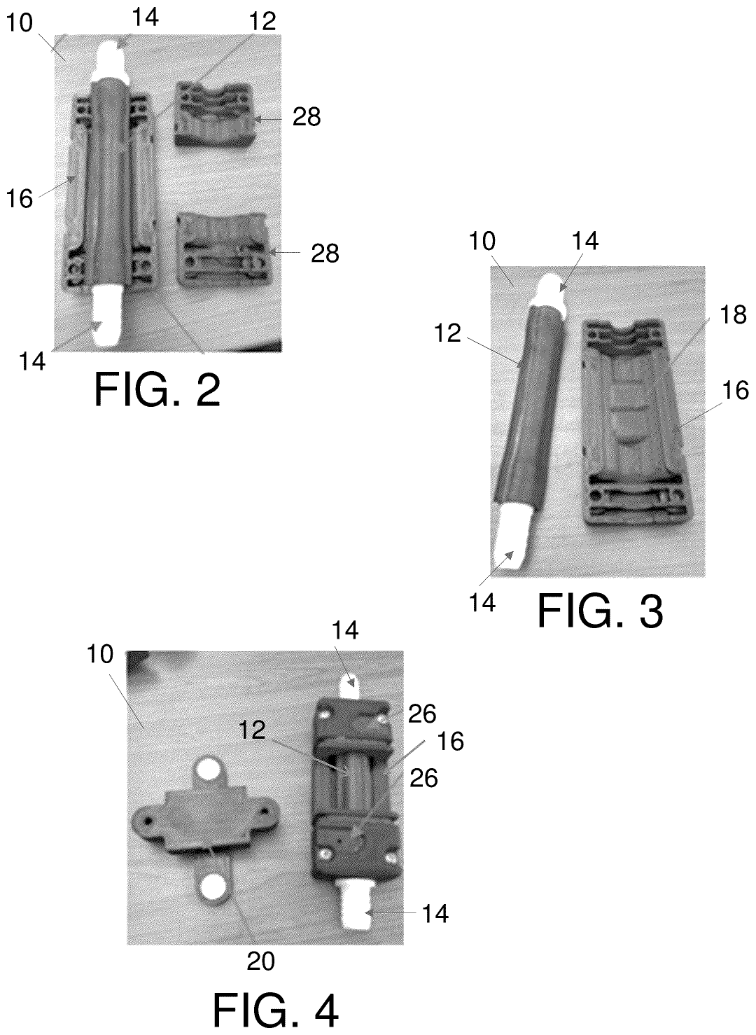

Turning to the figures in more detail, FIG. 1 shows a perspective view of the assembled device 10, while FIGS. 2-4 show various views of different components of the device disassembled. In various implementations, the device 10 includes of a pliable hose 12. The hose 12 may be similar to the hose 12/tubing used in agricultural squeeze pumps or more generally, peristaltic pumps. More specifically the hose/tubing 12 may be of a soft rubber material, while other materials are possible. In certain implementations, the hose/tubing 12 may have a short length, optionally about 6 inches, although other lengths and sizes are possible. The device 10 further includes a hose connector 14 (also referred to as a “hose barb” or “hose end fitting”) at each end of the hose 12. Various hose end fittings 14 would be appreciated by those of skill in the art. The hose end fittings 14 allowing the device 10 to be placed in-line within a fluid distribution system.

In various implementations, the hose end fittings 14 are retained by a housing 16 such that the position of the hose 12 and its length will not change due to expansion/compression of the hose 12. In these and other implementations, the ends of the hose 12 are compressed to the hose end fittings 14 so pressurized material will not leak out of the hose 12. The housing 16 retains and supports the hose end fittings 14.

The center portion of the housing 16 is shaped to contain the hose 12 profile so it cannot expand beyond its relaxed shape and supports it in a compressed state. A rib (also referred to as a “support area” or “compression surface”) 18 in the floor of the housing 16 at or near the center of the hose 12 length provides a compression line across the hose 12, shown in FIG. 3.

In various implementations, a compression plate (also referred to as a “clamp plate”) 20 acts on the surface of the hose 12 opposite the support area 18 in the housing 16. In these and other implementations, the compression plate 20 is attached to the housing 16 by a pair of draw rods 22 with springs 24 acting to push the compression plate 20 to squeeze/pinch/compress the hose 12 against the rib 18 in the housing 16, optionally forcing the hose 12 into a shut or fully compressed position such that fluid can no longer flow through the hose 12. Other methods of aligning and applying a constant compressive force on the compression plate 20 may also be used and would be understood by those of skill in the art. For example, a linear actuator or rotary actuator may be used to apply pressure to the compression plate 20, as will be discussed further herein.

In certain implementations, the compression plate 20 has a width that compresses the hose 12. In various implementations, the compression plate 20 width is 1.500″ with ½ of the width on either side of the support area 18. The support area 18 in the housing 16 floor allows the compression plate 20 to fully close the hose 16 at one point along its length with a minimum amount of spring pressure applied. In certain implementations, the housing 16 does not include a rib 18 and the compression plate 20 compresses the hose 12 directly against the housing 16 or other similar surface.

In various implementations, the device 10 also includes one or more position/distance sensors 26 and associated sensor covers 28. The sensor covers/holders 28 optionally forming part of the housing 16. The position/distance sensor 26 is discussed further below. Various descriptions of the device depict a the position/distance sensor 26 using two magnets 30 and two magnet sensors 26 to define the movement of the clamp plate 20 and to measure flow and/or blockage states (shown variously in FIGS. 4-7). Those skilled in the art would recognize that similar measurements could be taken using a single magnet 30 and magnet sensor 26 by taking advantage of a magnet sensors 26 ability to measure 3-dimensional position changes to determine the rate of flow and/or the existence of a blockage condition. Various alternative sensor 26 types are possible and would be understood by those of skill in the art.

### Flow Meter Operation

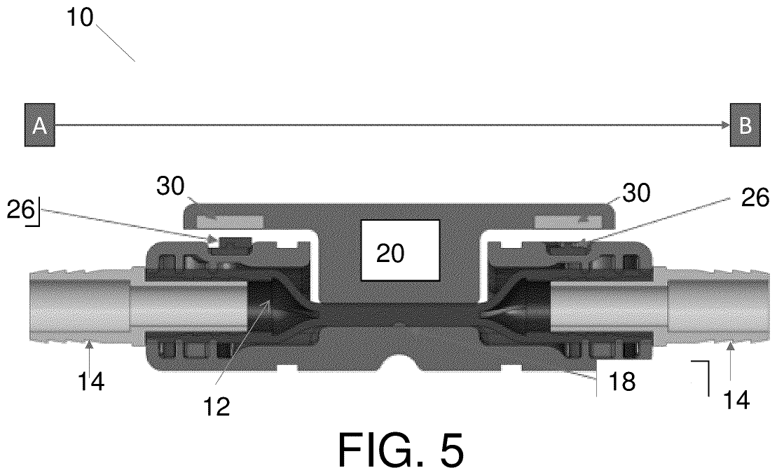

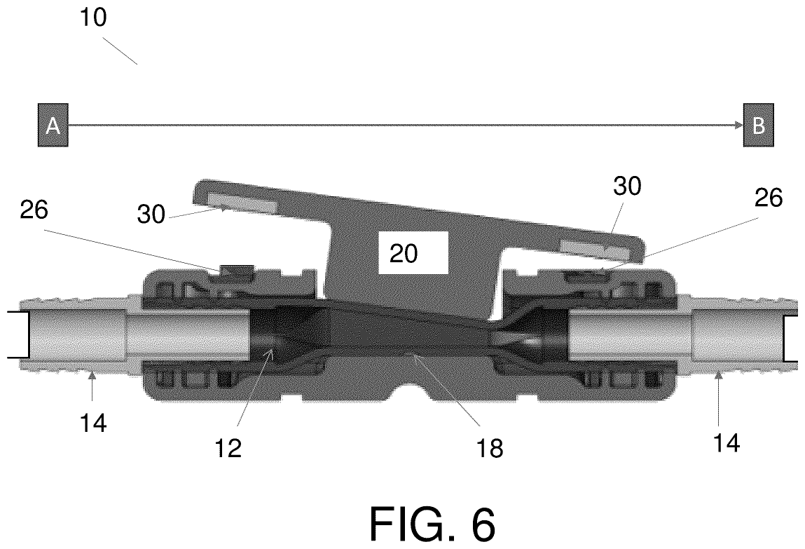

Turning now to FIGS. 5-6, the device 10 may be operated as a flow meter in various implementations. When operating as a flow meter, fluid pressure is supplied to the inlet end A of the hose 12. When a pump is activated, pressure builds at the inlet A and expands the hose 12 beginning at the point where the hose 12 is squeezed shut by the combination of the compression plate 20 and the rib 18 in the floor of the housing 18. Because the ends of the hose 12 are contained in the main housing 16 the hose 12 cannot grow in length, but the hose 12 can expand in diameter as pressure builds. As the diameter of the hose 12 expands the hose 12 pushes against the compression plate 20 exerting force to compress the springs 24 that hold the compression plate 20 against the outer surface of the hose 12. This creates a variable orifice in the hose 12. That is the opening within the hose 12 through which fluid flow can be of a variable size depending on the position of the compression plate 20 which may change based on the amount of pressure within the hose 12.

As pressure on the pump side of the orifice increases flow increases, further opening the variable orifice. That is, the pressure inside the hose 12 can overcome the force of the springs 24 pushing the compression plate 20 away from the center of the hose 12, such that the hose 12 opens allowing fluid to pass through the hose 12 toward the outlet B. As pressure increases so too does the pressure on the compression plate 20 increasing the size of the opening of the hose 12, allowing more fluid to flow through the device. This continues until pressure, flow, and the compression plate 20 position equalize at a new steady-state condition (shown in FIG. 6). For example, when the desired flow rate has been achieved.

In various implementations, the size of the orifice can be measured using sensing devices located external of the flow that measure the position of the compression plate 20. In various implementations, magnets 30 attached to the compression plate 20 and magnetic force sensors 26 (also referred to as “magnetometers”) are used to measure the position and orientation of the compression plate 20. Other types of sensors that can measure position could also be used, such as rotary encoders, cameras, vision sensors, and others as would be understood. In implementations having magnetometers 26, the larger the change in the magnetic field that is measured the larger the orifice is opened in the hose. The flow can be determined by calculating the orifice size and the pressure on the pump side of the sensor 26.

The flow measurement capability of the device 10 relies on relatively high pressure on the pump side of the variable orifice and little or no back pressure downstream after the variable orifice (towards or past the outlet B). The fluid being pumped through the flow meter 10 loses pressure and increases in flow velocity as it passes through the variable orifice. This is due to the Bernoulli principle which states that an increase in the speed of a fluid occurs simultaneously with a decrease in static pressure or a decrease in the fluid's potential energy.

In various implementations, the compression plate 20 follows the shape of the hose 12 and moves at an angle relative to its closed position. This angle can be measured by the position sensor 26 and used as additional information to calculate the flow through the flow meter 10. If there is a downstream restriction in the system 10, the differential pressure through the hose 12 will be reduced and the compression plate 20 will open at a different angle, more perpendicular to the flow. This can also be measured and used as information about the performance of the system 10.

This information could be but is not limited to information such as: partial blockage development; excess flow; unequal flow across parallel flow lines.

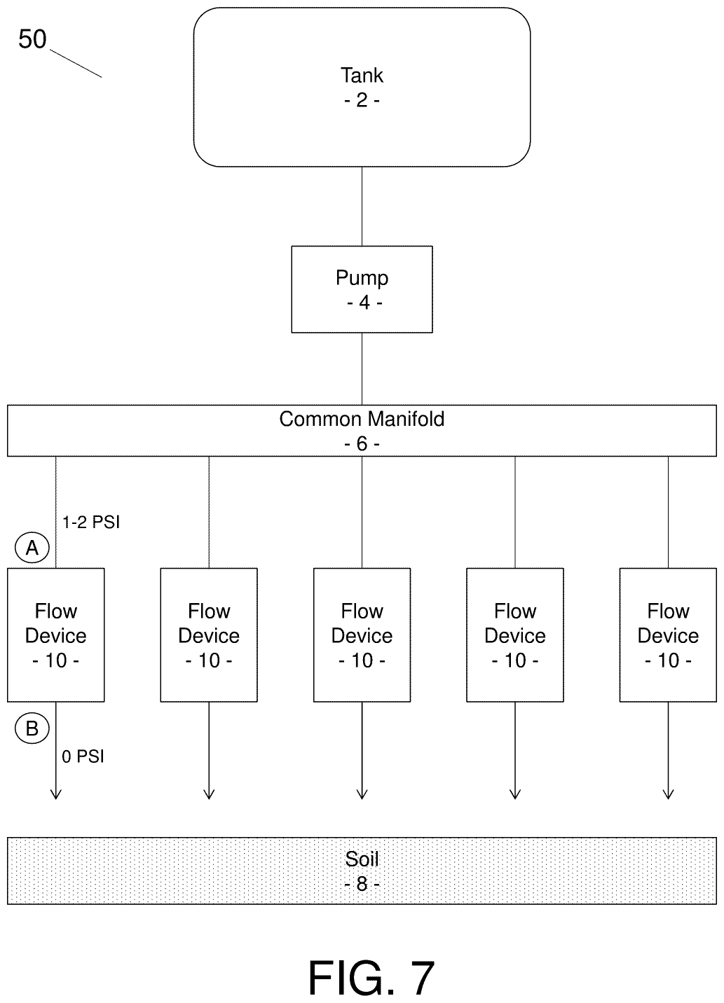

FIG. 7 shows and implementation of a fluid distribution system 50 where a tank 2 is in communication with a pump 4 to deliver a fluid to a common manifold 6. The common manifold 6 or fluid divider 6 then divides the flow from the tank 2 and pump 4 into individual lines. Each individual line may service a row unit, for example, of a planter. In various implementation, each individual line includes a flow device 10. In these implementations, at the inlet A of the flow device, fluid pressure is relatively high (optionally greater than 1 psi and may range up to and above 15 psi) and at the outlet B of the flow device 10 the fluid pressure is relatively low (optionally near 0 psi).

In the case of multiple parallel flow meters 10, the system 50 may look to determine if all of the flowmeters 10 are measuring the same or if some of them are measuring a difference when compared to the others. This difference in readings could be due to reduced flow due to a blockage or partial blockage in one or more of the individual lines, no flow due to a total blockage, or excess backpressure in the system 50 caused by attempting to produce too much flow with the pump 4 and exceeding the flow capacity of the discharge hoses. This could be caused, for example, by an incorrect pump 4 setting or by attempting to travel faster than the system 50 is designed to accommodate. For example, operating a planter at 12 MPH would require 2× the flow capacity of a system 50 originally designed to operate at 6 MPH.

### Flow Blockage Sensor

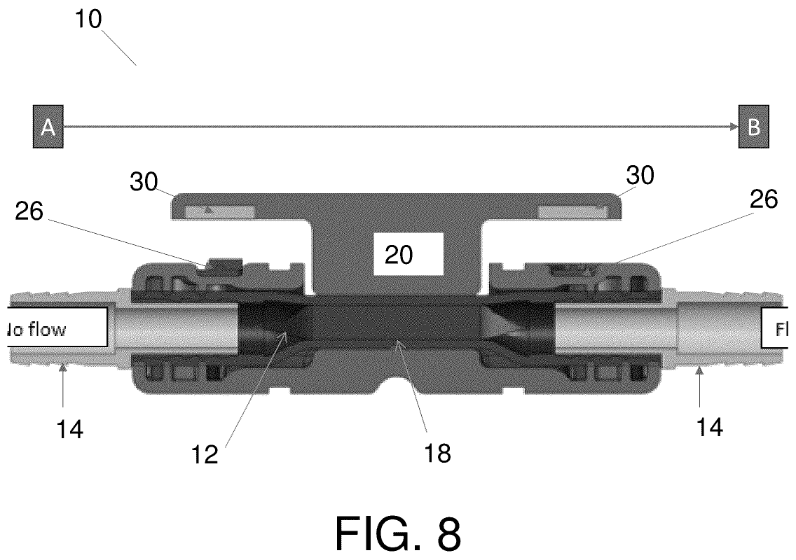

If the discharge of flow becomes blocked for any reason, the entire flow line pressure will rise to the pressure output of the pump 4. When this happens, the hose 12 expands equally along its length and lifts the compression plate 20 perpendicularly from its fully closed position, as shown in FIG. 8. This can be measured by the externally located sensor(s) 26. Because the compression plate 20 is moved but in a different angular position than it would be if flow were present then a blockage situation can be determined.

If the system 50 includes a single flow meter 10, the full pressure capacity of the pump 4 will be absorbed by the hose 12. The main housing 16 cavity is shaped to restrict the ability of the hose 12 to expand beyond its full flow diameter size so it cannot rupture or expand to a size leading to failure.

If the system 50 includes multiple flow meters 10 in parallel and one of the meters 10 output flow is blocked, the hose 12 will expand equally along its entire length and the compression plate 20 will move perpendicular to the flow. The flow from the pump 4 will be diverted to the remaining open flow meters 10. In this example, there will be two separate events that can be measured: (1) the position of the compression plate 20 on the meter 10 with the blocked flow; and (2) the increase in flow through the remaining open flow meters 10 based on the position of their respective compression plates 10.

### Self-Actuating Anti-Siphon Valve

As would be appreciated, in planter liquid fertilizer delivery systems, it is desirable to include a device to prevent the long runs of delivery hose from draining when flow from the pump has stopped such as during a turnaround at the end of a planting pass. It is also desirable to keep the supply hose full of liquid even if a low flow rate is being applied. This is to ensure consistent application rates and to prevent loss of fluid and a long delay in application while refilling a supply hose.

The disclosed device 10 can serve both purposes by closing the compression plate 20 and shutting off the flow path (outlet) when the pump has stopped supplying pressure and flow. In certain of these implementations, the device 10 can be located near the discharge location of the delivery tube on an individual row unit. That is, the device 10 may act as a valve.

### Flow Equalizer

Planter fertilizer delivery systems usually have a common single pump 4 delivering flow to a manifold 6 or flow divider 6, as discussed above in relation to FIG. 7. From the manifold 6 or flow divider 6, individual delivery hoses carry the liquid to the row units to be placed in or near the furrow. It would be understood that some of the delivery hoses will be longer than others and some will have a more difficult path to follow than others as the hose passes through fold points and other machine obstructions. These differences in flow lengths and paths in a gravity flow type system can lead to unequal delivery rates from row to row.

The flow meter 10 described herein allows for a small amount of back pressure (<15 psi) in a fertilizer application system 50 to open the variable orifice and move the compression plate 20. If all the flow meters 10 in a system are installed in parallel delivery hoses, the pump 4 pressure will cause the variable orifices to open equally and allow equal flow to be delivered to all rows eliminating the effects inconsistent flow path lengths and routing differences.

### Flow Shut Off and Flow Control

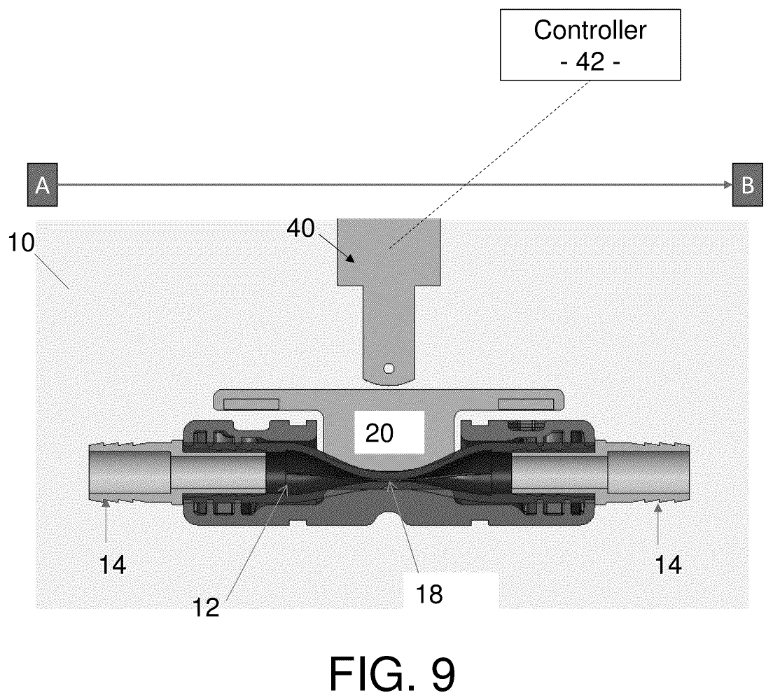

In certain implementations, optionally when a higher level of control is desired in a system, a linear position actuator 40 controlled by a computerized network/controller 42 may be used in plate of the springs 24 discussed above for control on the compression plate 20, shown in FIG. 9. Flow could then be metered by opening the variable orifice to a known size, by directly actuating a linear position actuator 40 via a controller 42.

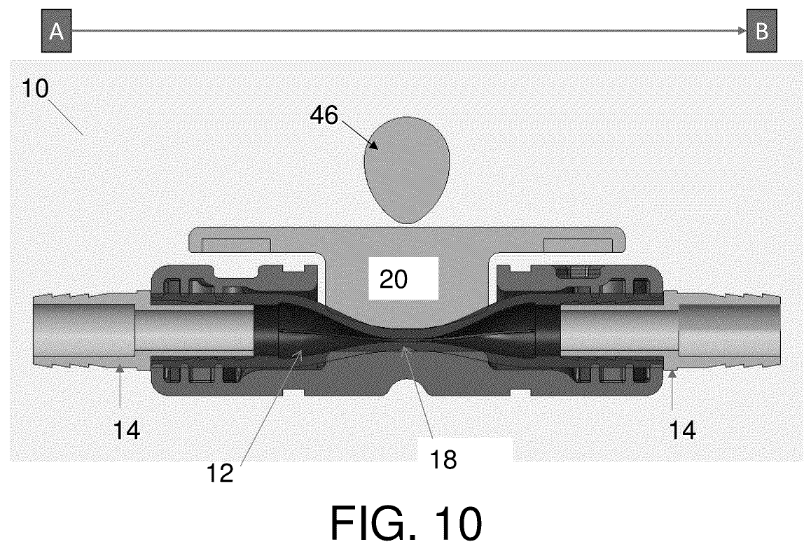

In various implementations, the pump output could also be controlled to maintain a known system pressure to ensure the output from each delivery hose is correct. If a row or rows pass into an area that does not require fertilizer such as a point row in an oddly shaped field the flow meter 10 on each of those rows could be closed to block flow and the pump output could be reduced to ensure the correct application rate is applied to the remaining rows. Alternately, in leu of a linear actuator 40 any device that can be commanded to apply a force sufficient to compress the variable orifice shut against the inlet pressure may be used, such as a rotary actuator and cam 46, shown in FIG. 10.

Similarly, in conditions where the planter is in a curve and the outer rows are traveling a greater distance than the inner rows, the linear actuators 40 could be set to meter out a flow rate that is correct for each row and the pump speed could be set to produce the total correct flow. Alternately, in leu of a linear actuator 40 any device that can be commanded to apply a force sufficient to compress the variable orifice shut against the inlet pressure may be used.

Although the disclosure has been described with references to various embodiments, persons skilled in the art will recognize that changes may be made in form and detail without departing from the spirit and scope of this disclosure.

What is claimed is:

1. A fluid flow device comprising:
(a) a hose;
(b) a housing wherein the hose is contained within the housing;
(c) a compression plate in operational communication with the housing configured to compress the hose against the housing; and
(d) a least one distance sensor configured to measure a position of the compression plate.

2. The fluid flow device of claim 1, wherein the distance sensor is one or more of a magnetic sensor, a vision sensor, and a rotary encoder.

3. The fluid flow device of claim 2, wherein the distance sensor is a magnetic sensor.

4. The fluid flow device of claim 1, further comprising a rib formed on the housing substantially opposite the compression plate.

5. The fluid flow device of claim 4, wherein the compression plate compresses the hose against the rib when the compression plate is in a closed position.

6. The fluid flow device of claim 1, further comprising an actuator in communication with the compression plate, the actuator configured to adjust the orientation of the compression plate relative to the hose.

7. The fluid flow device of claim 1, wherein the compression plate is configured for movement in response to increase fluid flow pressure within the hose, and wherein movement of the compression plate is read by the at least one distance sensor.

8. The fluid flow device of claim 7, wherein the position of the compression plate is indicative of a size of the hose opening within the housing and thereby of amount of fluid flowing through the hose.

9. The fluid flow device of claim 8, wherein the size of the hose opening is dynamically adjustable via change in pump pressure and/or via a linear actuator in communication with the compression plate.

10. A flow control and measurement device, comprising:
(a) a housing;
(b) a hose extending through the housing defining an orifice;
(c) a compression plate configured to press against the hose in the housing; and
(d) at least one position sensor configured to detect the position of the compression plate relative to the housing,
wherein the compression plate compresses the hose until the orifice is closed when the compression plate is in an off position, and wherein pressure from fluid flowing through the hose causes movement of the compression plate detected by the at least one position sensor.

11. The flow control and measurement device of claim 10, further comprising at least one linear actuator in communication with the compression plate, wherein the linear actuator urges the compression plate into a specified position to create a specified orifice size.

12. The flow control and measurement device of claim 10, wherein the position sensor is a non-contact sensor.

13. The flow control and measurement device of claim 10, wherein the position sensor is a magnetic sensor.

14. The flow control and measurement device of claim 10, wherein the device is configured to determine flow rate by determining the size of the orifice from the position of the compression plate and a known pump pressure feeding into the hose.

15. The flow control and measurement device of claim 10, further comprising at least one spring in communication with the compression plate, wherein the at least one spring forces the compression plate against the hose, and wherein the spring force may be overcome by fluid pressure within the hose urging the compression plate away from the housing.

16. The flow control and measurement device of claim 10, further comprising at least one compression rib within the housing, wherein the hose is pitched between the compression plate and the hose when the compression plate is in the off position.

17. A system for flow control and measurement, comprising:
(a) a fluid tank;
(b) a pump in communication with the fluid tank;
(c) a manifold in communication with the pump configured to distribute fluid flow to two or more individual lines; and
(d) at least one flow device in line with each of the two or more individual lines, the at least one flow device comprising:
(i) a housing;
(ii) a hose disposed within the housing;
(iii) a compression plate configured to compress the hose against the housing, the compression sufficient to close a lumen of the hose when fluid is not flowing through the hose; and
(iv) at least one sensor configured to determine the position of the compression plate relative to the housing,
wherein the position of the compression plate indicates pressure inside the hose.

18. The system for flow control and measurement of claim 17, further comprising comparing the pressure of each of the flow devices allows the system to determine if an individual line is blocked.

19. The system for flow control and measurement of claim 17, wherein the system equalizes flow amongst the two or more individual lines.

20. The system for flow control and measurement of claim 17, wherein the position of the compression plate indicates if a blockage is present.
